(19) United States
(12) Patent Application Publication
(10) Pub. No.: US 2012/0140053 A1
(43) Pub. Date: Jun. 7, 2012

(54) HEALTH MONITORING METHOD AND APPARATUS

(75) Inventors: Hong Soon Nam, Daejeon (KR); Hyung Soo Lee, Daejeon (KR)

(73) Assignee: ELECTRONICS AND TELECOMMUNICATIONS RESEARCH INSTITUTE, Daejeon (KR)

(21) Appl. No.: 13/298,784

(22) Filed: Nov. 17, 2011

(30) Foreign Application Priority Data
Dec. 2, 2010 (KR) 10-2010-0122232

(51) Int. Cl. H04N 7/18

(52) U.S. Cl. 348/77; 348/E07.085

(57) ABSTRACT

A health monitoring method of a health monitoring apparatus which wirelessly communicates with a wireless terminal and includes a camera module is provided. The apparatus establishes a connection with the wireless terminal and receives a control signal from the wireless terminal. The apparatus captures an image of a body part with the camera module in response to the control signal, and encodes the captured image into a digital image signal. The apparatus then packetizes the digital image signal and transmits the packetized signal to the wireless terminal.

### CROSS-REFERENCE TO RELATED APPLICATION

This application claims priority to and the benefit of Korean Patent Application No. 10-2010-0122232 filed in the Korean Intellectual Property Office on Dec. 2, 2010, the entire contents of which are incorporated herein by reference.

### BACKGROUND

(a) Field

The present invention relates to a health monitoring method and apparatus and, more particularly, to a health monitoring method and apparatus using a wireless terminal.

(b) Description of the Related Art

A conventional endoscope used as a health monitoring apparatus includes an object lens for observing an object and an ocular lens for viewing an object with eyes, but a recent endoscope captures an image of an observation portion through a camera and transfers image information to an image output device through wired or wireless communication, and then the image output device outputs a corresponding image.

A camera can be implemented as a subminiature camera which has a diameter of a few millimeters and is low-priced by using a charge coupled device (CCD) or a complementary metal oxide semiconductor (CMOS). However, it is not easy to reduce the size and cost of the image output device in order to satisfy the size and resolution for users to use.

### SUMMARY

Embodiments of the present invention provide a health monitoring method and apparatus for reducing the size and cost.

An embodiment of the present invention provides a health monitoring apparatus for which wirelessly communicates with a wireless terminal to perform a health monitoring function. The apparatus for health monitoring may include a camera module, a video encoder, a controller, and a transceiver. The camera module may capture an image of a body part, and the video encoder may encode the image captured by the camera module into a digital image signal. The controller may packetize the digital image signal, and control the camera module in response to a control signal from the wireless terminal. The transceiver may transmit the image signal packetized by the controller to the wireless terminal, and transfer the control signal received from the wireless terminal to the controller.

The transceiver may periodically transmit a beacon, receive a subscription request message which is transmitted by the wireless terminal according to the beacon, and transmit a subscription response message in response to the subscription request message. Here, a connection with the wireless terminal may be established according to the transmission of the subscription response message.

The transceiver may receive a probe request message transmitted from the wireless terminal, transmit a probe response message to the wireless terminal in response to the probe request message, and receive an acknowledgement message according to the probe response message. Here, a connection with the wireless terminal may be established according to reception of the acknowledgement message.

The apparatus may further include a light emitting unit configured to control illumination when the image is captured according to the control signal.

The controller may control at least one of an image capture direction and an image quality of the camera module in response to the control signal.

The apparatus may further include a power controller configured to supply power required for the apparatus.

The power controller may include: a rechargeable battery; a battery charging unit configured to charge the battery; a voltage controller configured to convert a voltage provided from an adapter into a voltage required for the battery charging unit; and an output controller configured to convert the voltage charged in the battery into a voltage required for the apparatus.

The voltage provided from the adapter may be equal to a voltage provided from an adapter for the wireless terminal.

Another embodiment of the present invention provides a health monitoring method of a health monitoring apparatus which wirelessly communicates with a wireless terminal and includes a camera module. The method includes establishing a connection with a wireless terminal, receiving a control signal from the wireless terminal, capturing an image of a body part with a camera module in response to the control signal, encoding the captured image into a digital image signal, packetizing the digital image signal, and transmitting the packetized digital image signal to the wireless terminal.

When establishing the connection, a beacon may be periodically transmitted, a subscription request message may be received from the wireless terminal according to the beacon, and a subscription response message may be transmitted to the wireless terminal in response to the subscription request message.

When establishing the connection, a probe request message may be received from the wireless terminal, a probe response message may be transmitted to the wireless terminal in response to the probe request message, and an acknowledgement message may be received from the wireless terminal according to the probe response message.

When the image is being captured, illumination may be adjusted in response to the control signal.

When capturing the image, an image capture direction of the camera module may be adjusted in response to the control signal.

The method may further include controlling an image setting of the camera module in response to the control signal.

Yet another embodiment of the present invention provides a health monitoring method of a wireless terminal which wirelessly communicates with a wireless camera. The method includes establishing a connection with the wireless camera, transmitting a control signal for controlling the wireless camera to the wireless camera, receiving an image signal captured by the wireless camera according to the control signal, configuring image information of the image signal in units of frames, displaying an image corresponding to the image information, providing a health monitoring menu, and providing an image service for the image according to a control signal input through the health monitoring menu.

When establishing the connection, a beacon may be received from the wireless camera, a subscription request message may be transmitted to the wireless camera, and a subscription response message may be received from the wireless camera according to the subscription request message.

When establishing the connection, a probe request message may be transmitted to the wireless camera, a probe response message may be received from the wireless camera according to the probe request message, and an acknowledgement message may be transmitted to the wireless camera in response to the probe response message.

The control signal may include at least one of information for controlling an image capture direction of the wireless camera, information for controlling brightness in image capturing, information for controlling quality in image capturing, and information for selecting any one of a video and a still image.

The image service may include at least one of a service of storing the image, a service of magnifying the image, a service of comparing the image with a different image, a service of transmitting the image to a health server that manages user's health information, and a service of displaying image information received from the health server.

The method may further include updating software of the wireless camera.

### BRIEF DESCRIPTION OF THE DRAWINGS

FIG. 1 is a schematic view of a health monitoring system according to an embodiment of the present invention.

FIG. 2 is a schematic block diagram of a wireless camera according to an embodiment of the present invention.

FIG. 3 is a schematic block diagram of a power controller in FIG. 2.

FIG. 4 is a schematic block diagram of a wireless terminal according to an embodiment of the present invention.

FIGS. 5 and 6 are views schematically showing a connection procedure of a wireless camera and a wireless terminal in the health monitoring system according to an embodiment of the present invention, respectively.

FIG. 7 is a flowchart illustrating the process of a method for health monitoring according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

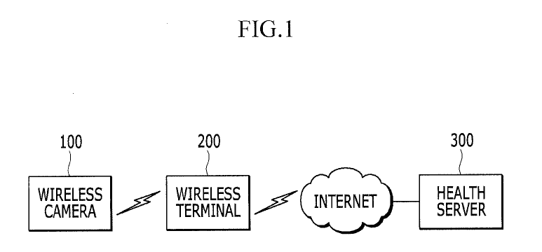

First, a health monitoring system according to an embodiment of the present invention will be described in detail with reference to FIGS. 1 to 4.

FIG. 1 is a schematic view of a health monitoring system according to an embodiment of the present invention.

Referring to FIG. 1, the health monitoring system includes a wireless camera 100, a wireless terminal 200, and a health server 300.

The wireless camera 100 captures an image of a body part such as a person's ear, nose, neck, or skin, or an image of an object, and transmits the captured image to the wireless terminal 200. The wireless camera 100 operates as a health monitoring apparatus.

The wireless terminal 200 may output the image received from the wireless camera 100 such that a user can observe it, or transfer the image to the health server 300. A terminal having a wireless communication function, like a mobile phone, may be used as the wireless terminal 200. A health monitoring application for controlling the wireless camera 100 and transmitting and receiving data may be installed in the wireless terminal 200. The health monitoring application may be added to or updated in the wireless terminal 200 through the Internet.

The health server stores and manages user's health and exercise information, and the wireless terminal 100 can access the information stored in the health server 300 through the health monitoring application.

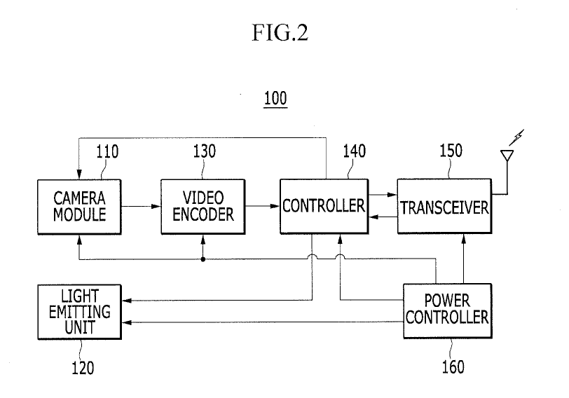

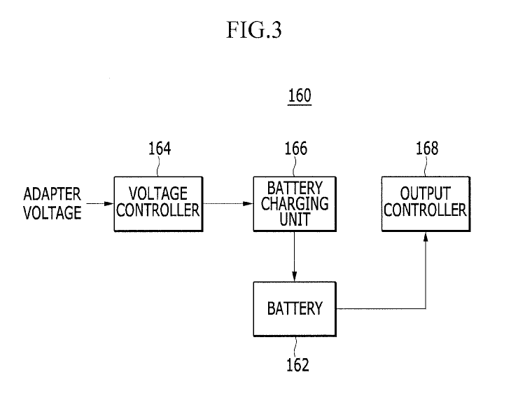

FIG. 2 is a schematic block diagram of a wireless camera according to an embodiment of the present invention, and FIG. 3 is a schematic block diagram of a power controller in FIG. 2.

Referring to FIG. 2, the wireless camera 100 includes a camera module 110, a light emitting unit 120, a video encoder 130, a controller 140, a transceiver 150, and a power controller 160.

The camera module 110 may capture an image through an image sensor such as a CCD, a CMOS, or the like, and may be controlled in a horizontal direction and/or a vertical direction. The light emitting unit 120 may control illumination when an image is captured by the camera module 110, and may include a light emitting diode or the like. The video encoder 130 encodes the image which has been captured by the camera module 110 into a digital signal. The video encoder 130 may select resolution and a compression method of the image signal under the control of the controller 140. The video encoder 130 may provide a mode for transmitting an image having low resolution without compression by minimizing delay time to allow the image to be observed in real time, and a mode for compressing an image by a compression codec, e.g., a joint photography experts group (JPEG) codec or a moving picture experts group (MPEG) codec to transmit the image with high resolution.

The controller 140 packetizes the image signal which has been converted into a digital signal to generate an image signal frame such that transceiver 150 can be wirelessly transmit and receive the image signal. The transceiver 150 modulates the image signal frame and transmits the modulated image signal frame to the wireless terminal 200. The transceiver 150 demodulates a signal received from the wireless terminal 200 and transfers the demodulated signal to the controller 140. The controller 140 performs a function corresponding to the demodulated signal. The controller 140 controls the operation of the camera module 110, the light emitting unit 120, the transceiver 150, and the like. For example, the controller 140 may packetize the image signal with an Internet protocol (IP)/user datagram protocol (UDP), convert the same into a medium access control (MAC) frame of a wireless body area network (WBAN), and transfer the converted frame to the transceiver 150. The transceiver 150 may modulate the image signal frame into a radio frequency (RF) signal and transmit the same. The controller 140 and the transceiver 150 may use a scheme such as a wireless personal area network (WPAN), Bluetooth™, Wi-Fi, or the like, besides the WBAN scheme.

Referring to FIG. 3, the power controller 160, which serves to provide power required for the wireless camera 100, includes a battery 162. The battery 162 may be a rechargeable battery. An adapter used in recharging a battery of the wireless terminal 200 may be used to recharge the battery 162 of the wireless camera 100. Here, the power controller 160 further includes a voltage controller 164, a battery charging unit 166, and an output controller 168. The voltage controller 164 converts a voltage provided from the adapter for the wireless terminal 200 into a voltage required for the battery charging unit 166, and transfers the converted voltage to the battery charging unit 166. The battery charging unit 166 charges the battery and indicates charge energy. The output controller 168 converts power charged in the battery into a voltage required for the wireless camera 100, and provides the converted voltage to the camera module 100, the light emitting unit 120, the video encoder 130, the controller 140, the transceiver 150, or the like.

The wireless camera 100 may further include a temperature sensor (not shown) to measure the temperature of a user's body part.

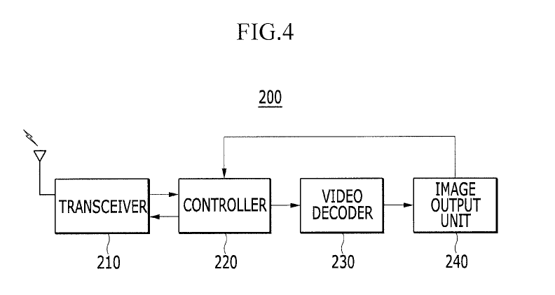

FIG. 4 is a schematic block diagram of a wireless terminal according to an embodiment of the present invention.

With reference to FIG. 4, the wireless terminal 200 includes a transceiver 210, a controller 220, a video decoder 230, and an image output unit 240

The transceiver 210 receives a signal transmitted from the wireless camera 100, demodulates the received signal, and transfers the demodulated signal to the controller 220. The controller 220, which includes a framework for the wireless terminal 200, classifies image information in the signal transferred from the transceiver 210 according to an application programming interface (API), removes packet overhead, and transfers the image information of the wireless camera 100 to the video decoder 230. Further, the controller 220 may update software installed in the controller 140 of the wireless camera 100 and for controlling the operation of the wireless camera 100.

The video decoder 230 decodes the image information to reconfigure the image information by frame, and transfers the reconfigured image information to the image output unit 240. In case of a non-compressed image signal, the video decoder 230 may immediately decode the non-compressed image signal. In case of a compressed image signal, the video decoder 230 may decompress the compressed image signal and then decode the same.

The image output unit 240 displays the image which has been captured by the wireless camera 100 based on the image information. Meanwhile, the image output unit 240 may provide a health monitoring menu for controlling the wireless camera 100 through a display screen to allow the user to control illumination, image quality in image capturing, an image capture direction, and the like. Here, a control message for the wireless camera 100 may be packetized by the controller 220, modulated by the transceiver 210, and then transmitted to the wireless camera 100.

The wireless terminal 200 may further include a power controller (not shown) for supplying power required for the wireless terminal 200.

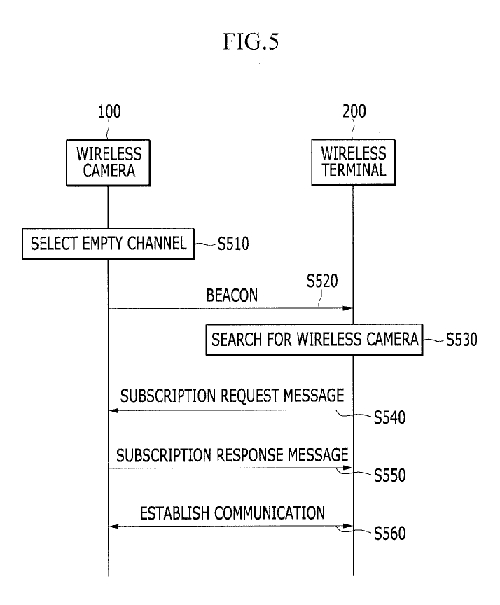

An operation of the health monitoring system according to an embodiment of the present invention will now be described in detail with reference to FIGS. 5 to 7.

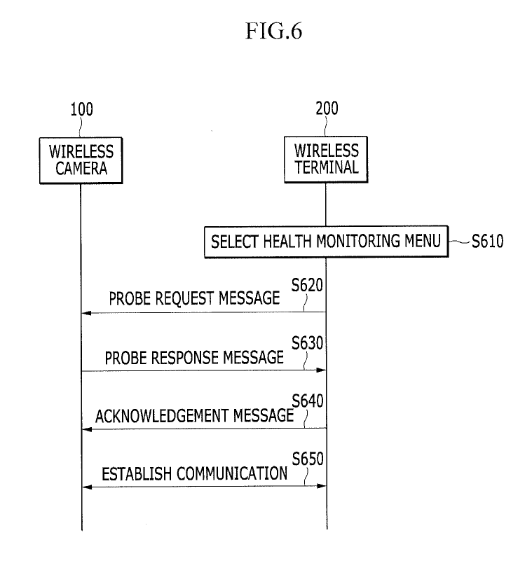

FIGS. 5 and 6 are views schematically showing a connection procedure of the wireless camera 100 and the wireless terminal 200 in the health monitoring system according to an embodiment of the present invention, respectively. Specifically, FIG. 5 shows a connection procedure starting from the wireless camera 100, and FIG. 6 shows a connection procedure starting from the wireless terminal 200.

Referring to FIG. 5, when power of the wireless camera 100 is turned on, the wireless camera 100 scans channels to select an empty channel which is not used by a different user. When an empty channel is selected, the transceiver 150 of the wireless camera 100 periodically transmits a beacon via the selected channel (S520). The beacon includes an identifier (ID) of the wireless camera 100, and may further include information such as a beacon period, a clock signal, or the like. The wireless terminal 200, while scanning channels, searches for a wireless camera it may use based on the beacon received via the scanned channel (S530). When the wireless camera 100 is searched, the wireless terminal 200 transmits a subscription request message to the wireless camera 100 (S540). Upon receiving the subscription request message, the wireless camera 100 transmits a subscription response message to the wireless terminal 200 (S550). When the wireless terminal 200 receives the subscription response message, it establishes bi-directional communication with the wireless camera 100 (S560). Through such processes, the wireless camera 100 and the wireless terminal 200 are connected.

Referring to FIG. 6, unlike the case of FIG. 4, when the user turns on power of the wireless camera 100 and selects the health monitoring menu in the wireless terminal 200, the wireless terminal 200 transmits a probe request message to search for a wireless camera (S620). Upon receiving the probe request message, the transceiver 150 of the wireless camera 100 transmits a probe response message to the wireless terminal 200. When the wireless terminal 200 receives the probe response message, it transits an acknowledgement message to the wireless camera 100 (S640). When the wireless camera 100 receives the acknowledgement message, it establishes bi-directional communication with the wireless terminal 200 (S650). Through the processes, the wireless camera 100 and the wireless terminal 200 are connected.

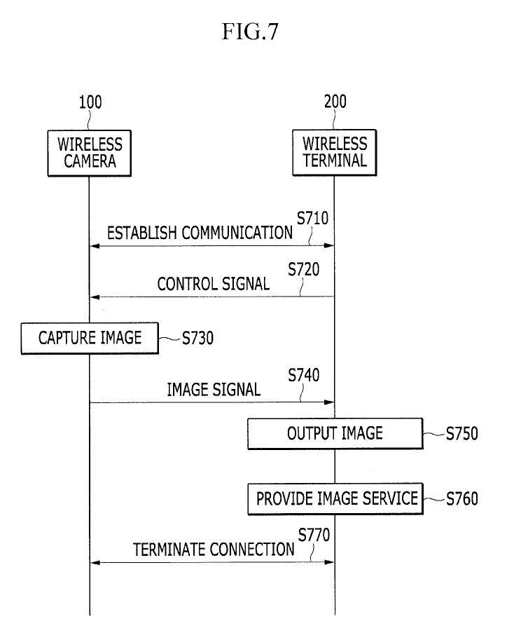

FIG. 7 is a flowchart illustrating the process of a health monitoring method according to an embodiment of the present invention.

Referring to FIG. 7, after the wireless camera 100 and the wireless terminal 200 are connected through the process as described above with reference to FIGS. 5 and 6 (S710), the wireless terminal 200 controls the camera module 100, the light emitting unit 120, and other image settings of the camera module 100 of the wireless camera 100, and transmits a control signal according to the controlling to the wireless camera 100 (S720). For example, items such as measurement of body temperature, transfer rate, brightness of illumination, and the like, besides image settings such as a selection of video or a still image, and a selection of resolution (image quality), may be controlled through the health monitoring menu provided from the image output unit 240 of the wireless terminal 200. The wireless camera 100 captures an image in response to the control signal from the wireless terminal 200 (S730), and transmits an image signal to the wireless terminal 200 (S740). The wireless terminal 200 outputs an image to the image output unit 240 based on the received image signal (S750). The wireless terminal 200 provides an image service according to controlling through the health monitoring menu of the user who has observed the image (S760). The image service may include at least one of services among magnifying/reducing an image, storing an image, transmitting an image to a different server (e.g., 300 in FIG. 1), comparing an image with a different image, and searching for relevant data. After the image observation and image service are terminated, the connection between the wireless terminal 200 and the wireless camera 100 is terminated (S770).

When the wireless camera 100 measures body temperature, it may transmit a signal with respect to the body temperature to the wireless terminal 200. In this case, the body temperature may be displayed in the form of a character or a figure on the image output unit 240.

As such, according to an embodiment of the present invention, since some of the functions required for the health monitoring apparatus are implemented in the wireless terminal, the health monitoring apparatus can be reduced in size, consume less power, and incur a low cost. Thus, the user can carry the health monitoring apparatus to easily observe his body part, an object, or the like, and as such, the health monitoring apparatus can be utilized for personal healthcare or the like, at homes or in outdoor areas.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A health monitoring apparatus which wirelessly communicates with a wireless terminal to perform a health monitoring function, the apparatus comprising:
a camera module configured to capture an image of a body part;
a video encoder configured to encode the image captured by the camera module into a digital image signal;
a controller configured to packetize the digital image signal, and control the camera module in response to a control signal from the wireless terminal; and
a transceiver configured to transmit the image signal packetized by the controller to the wireless terminal, and transfer the control signal received from the wireless terminal to the controller.

2. The apparatus of claim 1, wherein the transceiver periodically transmits a beacon, receives a subscription request message which is transmitted by the wireless terminal according to the beacon, and transmits a subscription response message in response to the subscription request message, and
wherein a connection with the wireless terminal is established according to the transmission of the subscription response message.

3. The apparatus of claim 1, wherein the transceiver receives a probe request message from the wireless terminal, transmits a probe response message to the wireless terminal in response to the probe request message, and receives an acknowledgement message according to the probe response message, and
wherein a connection with the wireless terminal is established according to reception of the acknowledgement message.

4. The apparatus of claim 1, further comprising a light emitting unit configured to control illumination when the image is captured according to the control signal.

5. The apparatus of claim 1, wherein the controller controls at least one of an image capture direction and an image quality of the camera module in response to the control signal.

6. The apparatus of claim 1, further comprising a power controller configured to supply power required for the apparatus.

7. The apparatus of claim 6, wherein the power controller comprises:
a rechargeable battery;
a battery charging unit configured to charge the battery;
a voltage controller configured to convert a voltage provided from an adapter into a voltage required for the battery charging unit; and
an output controller configured to convert a voltage charged in the battery into a voltage required for the apparatus.

8. The apparatus of claim 7, wherein the voltage provided from the adapter is equal to a voltage provided from an adapter for the wireless terminal.

9. A health monitoring method of a health monitoring apparatus which wirelessly communicates with a wireless terminal and includes a camera module, the method comprising:
establishing a connection with a wireless terminal;
receiving a control signal from the wireless terminal;
capturing an image of a body part with a camera module in response to the control signal;
encoding the captured image into a digital image signal;
packetizing the digital image signal; and
transmitting the packetized digital image signal to the wireless terminal.

10. The method of claim 9, wherein establishing the connection comprises:
periodically transmitting a beacon;
receiving a subscription request message from the wireless terminal according to the beacon; and
transmitting a subscription response message to the wireless terminal in response to the subscription request message.

11. The method of claim 9, wherein establishing the connection comprises:
receiving a probe request message from the wireless terminal;
transmitting a probe response message to the wireless terminal in response to the probe request message; and
receiving an acknowledgement message from the wireless terminal according to the probe response message.

12. The method of claim 9, wherein capturing the image comprises adjusting illumination in response to the control signal.

13. The method of claim 9, wherein capturing the image comprises adjusting an image capture direction of the camera module in response to the control signal.

14. The method of claim 9, further comprising controlling an image setting of the camera module in response to the control signal.

15. A health monitoring method of a wireless terminal which wirelessly communicates with a wireless camera, the method comprising:
establishing a connection with the wireless camera;
transmitting a control signal for controlling the wireless camera to the wireless camera;
receiving an image signal captured by the wireless camera according to the control signal;
configuring image information of the image signal in units of frames;
displaying an image corresponding to the image information;
providing a health monitoring menu; and
providing an image service for the image according to a control signal input through the health monitoring menu.

16. The method of claim 15, wherein establishing the connection comprises:
receiving a beacon from the wireless camera;
transmitting a subscription request message to the wireless camera in response to the beacon; and
receiving a subscription response message from the wireless camera according to the subscription request message.

17. The method of claim 15, wherein establishing the connection comprises:
transmitting a probe request message to the wireless camera;
receiving a probe response message from the wireless camera according to the probe request message; and
transmitting an acknowledgement message to the wireless camera in response to the probe response message.

18. The method of claim 15, wherein the control signal comprises at least one of information for controlling an image capture direction of the wireless camera, information for controlling brightness in image capturing, information for controlling quality in image capturing, and information for selecting any one of a video and a still image.

19. The method of claim 15, wherein the image service comprises at least one of a service of storing the image, a service of magnifying the image, a service of comparing the image with a different image, a service of transmitting the image to a health server that manages user's health information, and a service of displaying image information received from the health server.

20. The method of claim 15, further comprising updating software of the wireless camera.
